(19) United States
(12) Patent Application Publication
(10) Pub. No.: US 2018/0046102 A1
(43) Pub. Date: Feb. 15, 2018

(54) LIQUID DEVELOPER

(71) Applicant: CANON KABUSHIKI KAISHA, Tokyo (JP)

(72) Inventors: Naohiko Tsuchida, Tokyo (JP); Yasutaka Akashi, Yokohama-shi (JP); Yuzo Tokunaga, Chiba-shi (JP)

(21) Appl. No.: 15/667,679

(22) Filed: Aug. 3, 2017

(30) Foreign Application Priority Data
Aug. 9, 2016 (JP) 2016-156444
Jul. 19, 2017 (JP) 2017-140110

(51) Int. Cl. G03G 9/08; C09C 1/48

(52) U.S. Cl. CPC G03G 9/0806; C09C 1/48; G03G 9/087

(57) ABSTRACT

A liquid developer containing a curable insulating liquid, a cationic polymerization initiator, and a toner particle containing a binder resin and carbon black, wherein the carbon black is basic, or wherein the toner particle contains a carbon black dispersing agent, and the carbon black dispersing agent has a dispersing group and an adsorptive group, and the adsorptive group is an amino group.

### BACKGROUND OF THE INVENTION

### Field of the Invention

The present invention relates to a liquid developer used in an image-forming apparatus that utilizes an electrophotographic system.

### Description of the Related Art

Among image-forming apparatuses that utilize electrophotographic systems, attention has been drawn in recent years to high-speed, high-image quality digital printers based on wet developing systems, which are excellent for high-speed image formation.

Wet developing systems use a liquid developer in which toner particles, which are the developer, are dispersed in a liquid, and as a result toner particles can be used that are finer than in the developers used in dry developing systems. As a consequence, wet developing systems are characterized by the ability to form images of higher quality than in dry developing systems.

Dispersions of colored resin particles in electrically insulating liquids, e.g., a hydrocarbon organic solvent or silicone oil, are already known as liquid developers. However, a substantial reduction in image quality may be caused when the electrically insulating liquid remains present on the recording medium, e.g., paper or plastic film, thorough removal of the electrically insulating liquid is required. Evaporative removal of the electrically insulating liquid through the application of thermal energy is the method generally used for removal of the electrically insulating liquid. However, this is not necessarily desirable from an environmental standpoint or energy-savings standpoint when organic solvent vapor can be discharged from the machine and/or when large amounts of energy are required.

A method that has been proposed as a countermeasure here is to cause the electrically insulating liquid to undergo curing through a photopolymerization reaction. A photocurable liquid developer uses a reactive functional group-bearing monomer or oligomer as the electrically insulating liquid and also uses a dissolved photopolymerization initiator.

However, when carbon black is used for the colorant in a liquid developer, the photopolymerization initiator can react with the acid on the surface of the carbon black and a so-called dark polymerization reaction—in which the electrically insulating liquid undergoes curing but not through a photopolymerization reaction—can then occur.

Japanese Patent Application Laid-open No. 2003-57883 does contain a description of a dark polymerization reaction induced by the photopolymerization initiator, but does not touch on a dark polymerization reaction caused by a reaction between the photopolymerization initiator and carbon black colorant. Japanese Patent Application Laid-open No. 2012-141463 also provides a similar description of a dark polymerization reaction, but is silent on a dark polymerization reaction caused by a reaction between the photopolymerization initiator and carbon black colorant.

### SUMMARY OF THE INVENTION

Thus, as indicated in the preceding, several inventions that consider dark polymerization reactions in liquid developers have been disclosed. However, there is no specific mention of a dark polymerization reaction that occurs due to the photopolymerization initiator and carbon black present as a colorant. This is because it is quite difficult, without impairing the fixing performance of the electrically insulating liquid, to inhibit the dark polymerization reaction that occurs due to the photopolymerization initiator and carbon black.

Considering these circumstances, an object of the present invention is therefore to provide a liquid developer that, even though it contains a photopolymerization initiator and a toner particle that contains carbon black, provides an inhibition of the dark polymerization reaction-induced curing of the electrically insulating liquid and also has an excellent fixing performance.

The present invention relates to a liquid developer that comprises a curable insulating liquid, a cationic polymerization initiator, and a toner particle containing a binder resin and carbon black, wherein the carbon black is basic.

The present invention also relates to a liquid developer that contains a curable insulating liquid, a cationic polymerization initiator, and a toner particle containing a binder resin and carbon black, wherein the toner particle contains a carbon black dispersing agent, and the carbon black dispersing agent has a dispersing group and an adsorptive group, and the adsorptive group is an amino group.

The liquid developer of the present invention, even though it contains a photopolymerization initiator and a toner particle that contains carbon black, can provide an inhibition of the dark polymerization reaction-induced curing of the electrically insulating liquid and also has an excellent fixing performance.

Further features of the present invention will become apparent from the following description of exemplary embodiments.

### DESCRIPTION OF THE EMBODIMENTS

The present invention is described in detail in the following.

Unless specifically indicated otherwise, expressions such as “at least XX and not more than YY” and “XX to YY” that show numerical value ranges refer in the present invention to numerical value ranges that include the lower limit and upper limit that are the end points.

The present invention is a liquid developer that contains a curable insulating liquid, a cationic polymerization initiator, and a toner particle containing a binder resin and carbon black, wherein the carbon black is basic.

In the cationic polymerization initiator-mediated curing process of curable insulating liquids, generally a strong acid is first produced by the photolysis of the cationic polymerization initiator by exposure to ultraviolet radiation. This strong acid initiates the cationic polymerization of the curable insulating liquid and the curable insulating liquid then undergoes curing. However, the dark polymerization reaction is not produced through the action of light. Due to this, the present inventors carried out focused investigations into how the dark polymerization reaction is produced.

The following was identified as a result: in the dark polymerization reaction, the ligand of the photopolymerization initiator that is normally released under the effect of light energy, is released due to the action, on the photopolymerization initiator present in the curable insulating liquid, of acidic functional groups on the surface of the carbon black, thereby initiating the cationic polymerization of the curable insulating liquid. The present inventors therefore carried out investigations on inhibiting the dark polymerization reaction by focusing on the acidic functional groups on the carbon black surface. As a result, they found that the use of a basic carbon black is effective for inhibiting the dark polymerization reaction.

The materials constituting the liquid developer of the present invention are described in detail in the following.

<Carbon Black>

The carbon black used by the present invention characteristically is basic.

Carbon black typically has a large number of acidic functional groups on its surface. The dark polymerization reaction is produced due to the action of these acidic functional groups on the photopolymerization initiator. It was therefore thought that the use of a basic carbon black would be effective for suppressing the dark polymerization reaction.

Here, basic indicates that the pH is greater than 7.

The following, for example, can be used as such a carbon black: #4000B, #850, and MCF88 from Mitsubishi Chemical Corporation; Printex L and Printex 90 from Orion Engineered Carbons; and Nipex 35 from Degussa.

The pH of carbon black can be determined according to JIS K 6221-1982.

Moreover, viewed from the standpoint of stability, the carbon black preferably has functional groups obtained by substitution, by alkali metal, of a hydrogen atom in the acidic groups that are surface functional groups. The reason for this is thought to be that the alkali metal-substituted functional groups will likely reside on the carbon black surface in a stable manner on a long-term basis.

—COOH is an example of an acidic functional group on the carbon black surface. The alkali metal is preferably Na or K. —COONa and —COOK are preferred for the alkali metal-substituted functional group.

In addition, the specific surface area (BET) of the carbon black is preferably not more than 200 m²/g, more preferably not more than 150 m²/g, and still more preferably not more than 100 m²/g. This range is effective for inhibiting the dark polymerization reaction because it provides a smaller carbon black surface on which acid functional groups are present and thus provides a smaller chance for contact with the photopolymerization initiator. There are no particular limitations on the lower limit for the specific surface area (BET) of the carbon black. The specific surface area (BET) of the carbon black can be controlled using the particle size and surface treatments.

The carbon black can be produced by known methods and there are no particular limitations on its method of production. Examples in this regard are channel methods and furnace methods.

<Cationic Polymerization Initiator>

A characteristic feature of the liquid developer of the present invention is that it contains a cationic polymerization initiator as the photopolymerization initiator. Cationic polymerization initiators have fast reaction rates and can provide an excellent fixing performance.

The cationic polymerization initiator preferably contains a compound represented by the following formula (1).

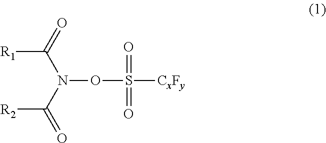

[In formula (1), R₁ and R₂ are bonded to each other to form a cyclic structure; x represents an integer of at least 1 and not more than 8; and y represents an integer of at least 3 and not more than 17.]

The cationic polymerization initiator represented by formula (1) undergoes photolysis upon exposure to ultraviolet radiation with the production of a sulfonic acid, a strong acid.

The use of the cationic polymerization initiator with formula (1), while making possible an excellent fixing performance, also provides a high-resistance liquid developer—unlike the case for the use of an ionic photoacid generator.

The ring structure formed by the bonding of R₁ to R₂ can be exemplified by five-membered rings and six-membered rings. Specific examples of the ring structure formed by the bonding of R₁ to R₂ are, for example, the succinimide structure, phthalimide structure, norbornenedicarboximide structure, naphthalenedicarboximide structure, cyclohexanedicarboximide structure, and epoxycyclohexenedicarboximide structure.

These ring structures may also have, as a substituent, an alkyl group having 1 to 18 carbons, an alkyloxy group having 1 to 18 carbons, an alkylthio group having 1 to 18 carbons, an aryl group having 1 to 14 carbons, an aryloxy group having 1 to 14 carbons, or an arylthio group having 1 to 14 carbons. Another ring structure, e.g., a possibly substituted alicycle, heterocycle, aromatic ring, and so forth, may also be condensed.

The CₓF_{y} group, which has a strong electron-withdrawing character, is a fluorocarbon group and is a functional group for bringing about decomposition of the sulfonate ester moiety upon exposure to ultraviolet radiation. The number of carbon atoms here is at least 1 and not more than 8 (x is at least 1 and not more than 8), and the number of fluorine atoms is at least 3 and not more than 17 (y is at least 3 and not more than 17).

Synthesis of the strong acid proceeds readily when the number of carbon atoms is at least 1, while the storage stability is excellent when the number of carbon atoms is not more than 8. The number of carbon atoms is preferably at least 1 and not more than 4.

Function as a strong acid is possible when the number of fluorine atoms is at least 3, while synthesis of the strong proceeds readily when the number of fluorine atoms is not more than 17. The number of fluorine atoms is preferably at least 3 and not more than 9.

The CₓF_{y} group in formula (1) can be exemplified by linear alkyl groups in which the hydrogen atom has been substituted by the fluorine atom, branched-chain alkyl groups in which the hydrogen atom has been substituted by the fluorine atom, cycloalkyl groups in which the hydrogen atom has been substituted by the fluorine atom, and aryl groups in which the hydrogen atom has been substituted by the fluorine atom.

The linear alkyl groups in which the hydrogen atom has been substituted by the fluorine atom can be exemplified by the trifluoromethyl group (x=1, y=3), pentafluoroethyl group (x=2, y=5), heptafluoro-n-propyl group (x=3, y=7), nonafluoro-n-butyl group (x=4, y=9), perfluoro-n-hexyl group (x=6, y=13), and perfluoro-n-octyl group (x=8, y=17).

The branched-chain alkyl groups in which the hydrogen atom has been substituted by the fluorine atom can be exemplified by the perfluoroisopropyl group (x=3, y=7), perfluoro-tert-butyl group (x=4, y=9), and perfluoro-2-ethylhexyl group (x=8, y=17).

The cycloalkyl groups in which the hydrogen atom has been substituted by the fluorine atom can be exemplified by the perfluorocyclobutyl group (x=4, y=7), perfluorocyclopentyl group (x=5, y=9), perfluorocyclohexyl group (x=6, y=11), and perfluoro(1-cyclohexyl)methyl group (x=7, y=13).

The aryl groups in which the hydrogen atom has been substituted by the fluorine atom can be exemplified by the pentafluorophenyl group (x=6, y=5) and 3-trifluoromethyltetrafluorophenyl group (x=7, y=7).

Among CₓF_{y} groups with formula (1), the linear alkyl groups, branched-chain alkyl groups, and aryl groups are preferred from the standpoint of the ease of acquisition and the decomposability of the sulfonate ester moiety. The linear alkyl groups and aryl groups are more preferred. The trifluoromethyl group (x=1, y=3), pentafluoroethyl group (x=2, y=5), heptafluoro-n-propyl group (x=3, y=7), nonafluoro-n-butyl group (x=4, y=9), and pentafluorophenyl group (x=6, y=5) are particularly preferred.

From the standpoint of the fixing performance, the compound with formula (1) is more preferably a compound represented by the following formula (2).

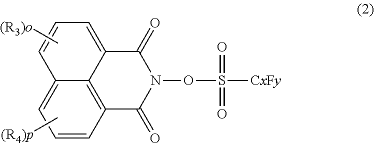

[In formula (2), x represents an integer of at least 1 and not more than 8 and y represents an integer of at least 3 and not more than 17. R₃ and R₄ each independently represent an alkyl group, alkyloxy group, alkylthio group, aryl group, aryloxy group, or arylthio group, and o and p represent integers of at least 0 and not more than 3. When o is equal to or greater than 2, a plurality of the R₃ may be bonded to each other to form a ring structure, and when p is equal to or greater than 2, a plurality of the R₄ may be bonded to each other to form a ring structure. In addition, an R₃ and R₄ may be bonded to each other to form a ring structure.]

Preferably R₃ and R₄ each independently represent an alkyl group having at least 1 and not more than 18 carbons, an alkyloxy group having at least 1 and not more than 18 carbons, an alkylthio group having at least 1 and not more than 18 carbons, an aryl group having at least 1 and not more than 14 carbons, an aryloxy group having at least 1 and not more than 14 carbons, or an arylthio group having at least 1 and not more than 14 carbons.

Specific examples (exemplary compounds A-1 to A-27) of the cationic polymerization initiator represented by formula (1) are provided below, but the present invention is not limited to these examples.

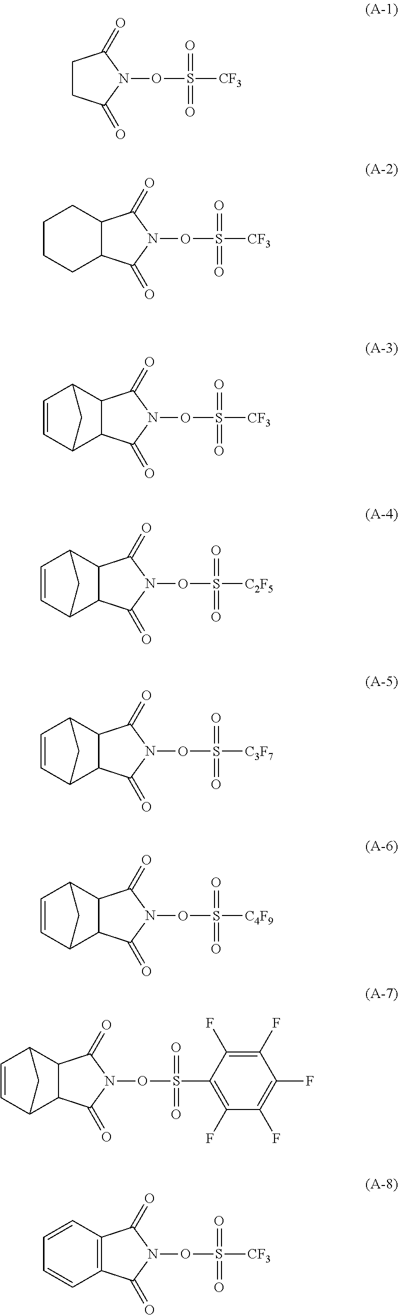

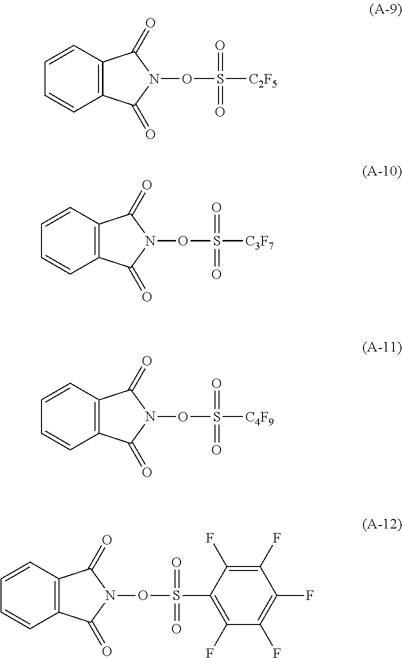

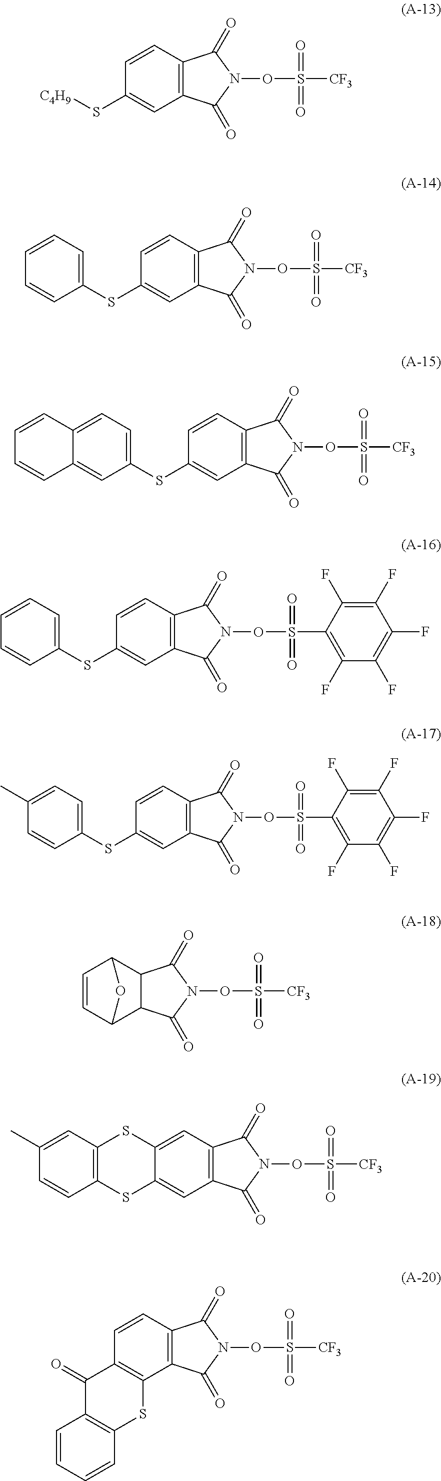

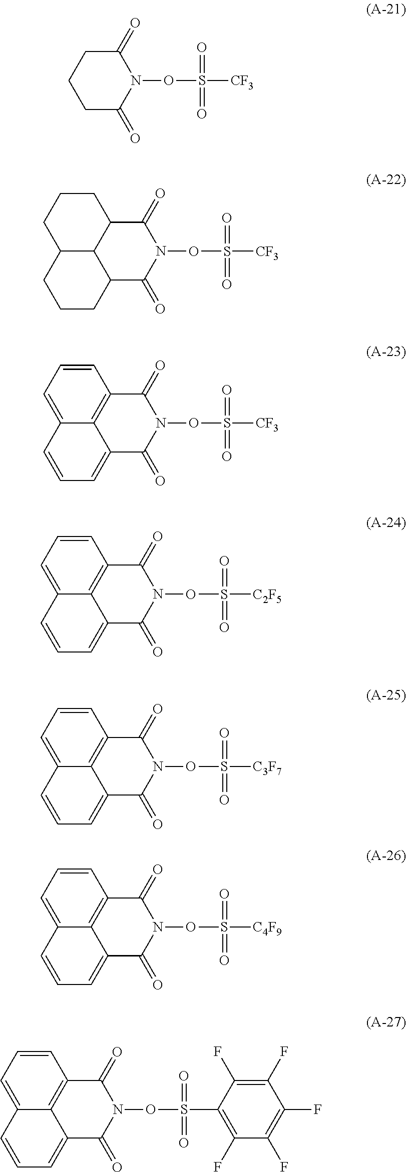

A single cationic polymerization initiator or a combination of two or more can be used. In addition, a cationic polymerization initiator other than a compound with formula (1) may be incorporated to the extent that the effects of the present invention are not impaired.

The content of the cationic polymerization initiator is preferably at least 0.01 mass part and not more than 10 mass parts per 100 mass parts of the curable insulating liquid.

<Curable Insulating Liquid>

Curable insulating liquids usable in the present invention are liquids that are made of cationically polymerizable monomer, have a high volume resistivity, are electrically insulating, and have a low viscosity at around room temperature, but are not otherwise particularly limited.

The cationically polymerizable monomer can be exemplified by vinyl ether compounds, epoxy compounds, acrylic compounds, and oxetane compounds.

Among these, vinyl ether compounds are preferred from the standpoint of human safety, high resistance, and low viscosity.

Here, vinyl ether compound refers to a compound that has a vinyl ether structure (—CH═CH—O—C—).

This vinyl ether structure is preferably represented by R—CH═CH—O—C— (R is hydrogen or C₁₋₃ alkyl and is preferably hydrogen or methyl).

The vinyl ether compound can be exemplified by butylethylpropanediol divinyl ether (BEPDVE), n-octyl vinyl ether, 2-ethylhexyl vinyl ether, dodecyl vinyl ether, octadecyl vinyl ether, benzyl vinyl ether, dicyclopentadiene vinyl ether, cyclohexanedimethanol divinyl ether, tricyclodecane vinyl ether, trimethylolpropane trivinyl ether, 2-ethyl-1,3-hexanediol divinyl ether, 2,4-diethyl-1,5-pentanediol divinyl ether, 2-butyl-2-ethyl-1,3-propanediol divinyl ether, neopentyl glycol divinyl ether, pentaerythritol tetravinyl ether, and 1,2-decanediol divinyl ether.

A photopolymerization initiator and/or a photopolymerization sensitizer may also be used in combination with the cationically polymerizable monomer. Any known compound can be used for this photopolymerization initiator or photopolymerization sensitizer as long as it does not excessively lower the volume resistivity of the liquid developer and does not excessively increase its viscosity.

<Binder Resin>

A known binder resin that exhibits a fixing performance for the adherend, e.g., paper or plastic film, can be used as the binder resin as long as it is insoluble in the curable insulating liquid. Here, “insoluble in the curable insulating liquid” indicates that not more than 1 mass part of the binder resin dissolves in 100 mass parts of the curable insulating liquid.

Such a binder resin can be exemplified by epoxy resins, polyester resins, (meth)acrylic resins, styrene-(meth)acrylic resins, alkyd resins, polyethylene resins, ethylene-(meth)acrylic resins, and rosin-modified resins. As necessary, a single one of these may be used or two or more may be used in combination.

The content of the binder resin is not particularly limited, but is preferably at least 50 mass parts and not more than 1,000 mass parts per 100 mass parts of the carbon black.

The toner particle concentration in the liquid developer is preferably at least 1 mass % and not more than 70 mass %.

The present inventors also discovered that—when the toner particle contains a carbon black dispersing agent and this carbon black dispersing agent has a dispersing group and an adsorptive group, and the adsorptive group is an amino group—the dark polymerization reaction can be inhibited while also obtaining an excellent fixing performance.

As noted above, the dark polymerization reaction is produced by the action of acidic functional groups on the carbon black surface on the photopolymerization initiator present in the liquid developer.

Focusing on this reaction mechanism, the present inventors then found that an inhibitory effect on the dark polymerization reaction is obtained by the bonding of the acidic functional groups resident on the carbon black surface with the amino group present in the adsorptive group of the carbon black dispersing agent.

The details of usable carbon black dispersing agents are provided in the following.

<Carbon Black Dispersing Agent>

The carbon black dispersing agent characteristically has a dispersing group and an adsorptive group wherein the adsorptive group is an amino group.

The dispersing group can be, e.g., a hydrophobic group, for example, a long-chain (preferably about 8 to 100 carbons) alkyl group.

This carbon black dispersing agent can be exemplified by Ajisper PB821 and Ajisper PB881 from Ajinomoto Fine-Techno Co., Inc. and Solsperse 11200 and Solsperse 18000 from Lubrizol Japan Limited. A single carbon black dispersing agent or a combination of two or more can be used.

From the standpoint of the dispersibility, the content of the carbon black dispersing agent is preferably at least 1 mass part and not more than 100 mass parts per 100 mass parts of the carbon black.

There is no particular limitation on the method for adding the carbon black dispersing agent, but from the standpoint of the dispersibility it is preferably mixed with and dispersed into the carbon black prior to mixing the carbon black with the binder resin.

<Toner Particle Dispersing Agent>

A toner particle dispersing agent may also be used in the liquid developer. The toner particle dispersing agent functions to stably disperse the toner particles in the curable insulating liquid, and there are no particular limitations on the type as long as it can be used for this purpose. The toner particle dispersing agent may undergo dissolution or dispersion in the carrier liquid. Examples of such dispersing agents are Ajisper PB817 from Ajinomoto Fine-Techno Co., Inc. and Solsperse 11200, 13940, 17000, and 18000 from Lubrizol Japan Limited. This dispersing agent may be added at at least 0.5 mass parts and not more than 30 mass parts per 100 mass parts of the toner particle. The toner particle dispersibility is further improved by use within this range.

<Charge Adjuvant>

A charge adjuvant can be incorporated with the goal of adjusting the charging behavior of the toner particle. A known charge adjuvant can be used.

Examples of specific compounds are as follows: metal soaps such as zirconium naphthenate, cobalt naphthenate, nickel naphthenate, iron naphthenate, zinc naphthenate, cobalt octanoate, nickel octanoate, zinc octanoate, cobalt dodecanoate, nickel dodecanoate, zinc dodecanoate, aluminum stearate, aluminum tristearate, and cobalt 2-ethylhexanoate; metal sulfonates such as petroleum-based metal sulfonates and the metal salts of sulfosuccinate esters; phospholipids such as lecithin; metal salicylates such as metal t-butylsalicylate complexes; polyvinylpyrrolidone resins; polyamide resins; sulfonic acid-containing resins; and hydroxybenzoic acid derivatives.

<Other Substances>

Various known additives may as necessary be used in the liquid developer of the present invention with the goal of improving the compatibility with recording media, the image storability, and other characteristics. For example, surfactant, lubricant, filler, antifoaming agent, ultraviolet absorber, antioxidant, anti-fading agent, anticorrosion agent, and so forth can be selected and used as appropriate.

<Production Method>

The method of producing the liquid developer is not particularly limited in the present invention and can be exemplified by known methods, for example, the coacervation method and the wet pulverization method.

The details of the coacervation method are described in, for example, Japanese Patent Application Laid-open No. 2003-241439, WO 2007/000974, and WO 2007/000975.

In the coacervation method, carbon black, binder resin, solvent that dissolves the binder resin, and solvent that does not dissolve the binder resin are mixed and the solvent that dissolves the binder resin is then removed from the mixture to cause the binder resin that had been dissolved to precipitate, thereby creating a dispersion of carbon black-enclosing toner particles in the solvent that does not dissolve the binder resin.

The details of the wet pulverization method, on the other hand, are described in, for example, WO 2006/126566 and WO 2007/108485.

In the wet pulverization method, the carbon black and binder resin are kneaded at or above the melting point of the binder resin; this is followed by a dry pulverization; and the obtained pulverized material is subjected to a wet pulverization in an electrically insulating medium, thereby dispersing the toner particles in the electrically insulating medium.

Known methods such as these can be used in the present invention.

The methods used to measure the properties related to the present invention are described in the following.

### (1) pH of the Carbon Black

The pH of the carbon black was measured based on JIS K 6221-1982.

### (Separation of the Carbon Black in the Liquid Developer)

The carbon black is separated from the liquid developer by the following method to enable measurement of the pH and specific surface area. The carbon black in the toner can be extracted by subjecting the toner to a dispersion treatment in toluene to dissolve the binder resin and by then separating the carbon black using filter paper and subjecting it to a washing and drying process.

### (2) Measurement of the Substituents on the Carbon Black Surface

The substituents on the carbon black surface were measured by carrying out analysis of the surface composition using X-ray photoelectron spectroscopy (instrument name: PHI 5000 VersaProbe II, ULVAC-PHI, Inc.).

The principal conditions are as follows.

output: 100μ, 25 W, 15 kV
measurement range: 300 μm×300 μm

### Pass Energy: 23.5 eV

### Step Size: 0.1 eV

The surface substituent groups on the carbon black were identified in the present invention using the peak intensities measured for the individual elements and the relative sensitivity factors provided by ULVAC-PHI, Inc.

### (3) Measurement of the Specific Surface Area (BET) of the Carbon Black

The BET specific surface area of the carbon black was measured based on JIS Z 8830 (2001). The specific measurement method is as follows.

A “TriStar 3000 Automatic Specific Surface Area Porosimetry Analyzer” (Shimadzu Corporation), which uses gas adsorption by a constant volume procedure as its measurement methodology, was used as the measurement instrument. The measurement conditions were set and the measurement data was analyzed using “TriStar 3000 Version 4.00”, the dedicated software provided with this instrument. A vacuum pump, nitrogen gas line, and helium gas line were connected to the instrument. The value calculated using a multipoint BET method and using nitrogen gas as the adsorption gas was used as the specific surface area of the carbon black in the present invention.

### (4) Compositional Analysis

The following procedure was used for the structural identification of the compounds and so forth.

Measurement of the ¹H-NMR and ¹³C-NMR spectra was carried out using an ECA-400 (400 MHz) from JEOL Ltd.

The measurements were carried out at 25° C. in a deuterated solvent containing tetramethylsilane as the internal reference substance. The chemical shift value was reported as the shift value in ppm (6 value) using 0 for the tetramethylsilane internal reference substance.

### EXAMPLES

The basic constitution and characteristics of the present invention are described above, while the present invention is specifically described in the following based on examples. However, the present invention is in no way limited to or by these.

Unless specifically indicated otherwise, the parts and % in the following blends indicate, respectively, mass parts and mass %.

<Carbon Black 1>

Carbon black 1 having a BET of 65 m²/g was obtained by introducing NaOH into the furnace using an alkali burner during carbon black production by the furnace method.

When the resulting carbon black 1 was analyzed, Na originating from COONa groups that were functional groups residing on the carbon black surface was detected. The pH was 9.0.

<Carbon Black 2>

Carbon black 2 was obtained proceeding as in the production example for carbon black 1, but changing the NaOH to KOH. The property values for carbon black 2 are given in Table 1.

<Carbon Black 3>

#4000B (Mitsubishi Chemical Corporation) was used as carbon black 3. The property values for carbon black 3 are given in Table 1.

<Carbon Black 4>

Printex L (Orion Engineered Carbons) was used as carbon black 4. The property values for carbon black 4 are given in Table 1.

<Carbon Black 5>

Printex 85 (Orion Engineered Carbons) was used as carbon black 5. The property values for carbon black 5 are given in Table 1.

<Carbon Black 6>

Printex 95 (Orion Engineered Carbons) was used as carbon black 6. The property values for carbon black 6 are given in Table 1.

<Carbon Black 7>

Color Black FW18 (Orion Engineered Carbons) was used as carbon black 7. The property values for carbon black 7 are given in Table 1.

<Carbon Black 8>

MA77 (Mitsubishi Chemical Corporation) was used as carbon black 8. The property values for carbon black 8 are given in Table 1.

<Carbon Black Dispersing Agents 1 to 3>

The carbon black dispersing agents 1 to 3 used in these examples and comparative examples are given in Table 2.

<Binder Resin>

| | |
|---|---|
| bisphenol A/2.3 mol ethylene | 40 parts |
| oxide adduct (BPA-EO) | |
| terephthalic acid (TFA) | 40 parts |
| tetrabutyl titanate (TNBT) | 0.2 parts |

These materials were introduced and a reaction was carried out for 10 hours under a nitrogen current at 220° C. while distilling out the produced water. A reaction was then carried out under a reduced pressure of 5 to 20 mmHg, followed by cooling to 180° C. and the addition of 20 parts of trimellitic anhydride (TMA). A reaction was carried out for 2 hours at normal pressure under seal, and this was followed by removal, cooling to room temperature, and then pulverization to obtain a polyester resin. The resulting polyester resin was dissolved in THF at 50 mass % to provide the binder resin used in the present invention.

<Liquid Developer 1>

| | |
|---|---|
| carbon black 1: | 10 parts |
| carbon black dispersing agent: | 10 parts |
| (Ajisper PB-821, contains amino group, | |
| Ajinomoto Fine-Techno Co., Inc.) | |
| tetrahydrofuran (THF): | 80 parts |

were mixed and were stirred for 1 hour with a paint shaker using glass beads having a diameter of 2 mm to obtain a pigment-dispersed slurry 1. Then,

| | |
|---|---|
| pigment-dispersed slurry 1: | 60 parts |
| binder resin (the previously described solution | 80 parts |
| of resin dissolved in THF at 50 mass %): | |
| toner particle dispersing agent: | 12 parts |
| (Ajisper PB-817, basic, Ajinomoto | |
| Fine-Techno Co., Ltd.) | |

were mixed with a high-speed disperser (T.K. Robomix/T.K. Homodisper Model 2.5 blade, Primix Corporation) and mixing was carried out while stirring at 40° C. to obtain a pigment dispersion 1.

While stirring at high speed (rotation rate=15,000 rpm) using a homogenizer (Ultra-Turrax T50, IKA-Werke GmbH & Co. KG), 200 parts of dodecyl vinyl ether (DDVE) was added in small portions to the pigment dispersion 1 (100 parts) obtained as described above to obtain a mixture 1.

The obtained mixture 1 was transferred to a pear-shaped recovery flask and the THF was completely distillatively removed at 50° C. while performing ultrasound dispersion, to obtain a toner particle dispersion 1 containing toner particles in a curable insulating liquid.

The resulting toner particle dispersion 1 (10 parts) was subjected to a centrifugal separation process; the supernatant was removed by decantation; replacement was carried out with fresh DDVE in the same amount as the removed supernatant; and redispersion was performed.

A liquid developer 1 was then obtained by the addition of 0.10 parts of a hydrogenated lecithin (product name: Lecinol S-10, Nikko Chemicals Co., Ltd.), 90 parts of butylethylpropanediol divinyl ether (BEPDVE) as the curable insulating liquid (liquid polymerizable monomer), 0.30 parts of a cationic polymerization initiator (product name: NHNI-PFBS, Toyo Gosei Co., Ltd.), and 1 parts of KAYAKURE-DETX-S (Nippon Kayaku Co., Ltd.).

The toner particles present in the resulting toner particle dispersion had a volume median diameter D50 of 0.7 μm.

(The toner particle size distribution was measured using a Nanotrac 150 (Nikkiso Co., Ltd.), which is a particle size distribution analyzer based on dynamic light scattering (DLS)).

<Liquid Developers 2 to 14>

Liquid developers 2 to 14 were obtained proceeding as in the production of liquid developer 1, but changing the carbon black, curable insulating liquid, cationic polymerization initiator, and carbon black dispersing agent as shown in Table 3. The composition and properties of liquid developers 2 to 14 are given in Table 3.

### Example 1

### (Dark Polymerization Reaction)

The liquid developer 1 was held in a dark location in a 50° C. environment and the occurrence of curing due to the dark polymerization reaction was checked on each day of standing. The following criteria were then used for the evaluation.

AA: No curing after at least 30 days.

### A: Cured at day 21 to 30.

### B: Cured at day 16 to 20.

### C: Cured at day 11 to 15.

### D: Cured at day 6 to 10.

E: Cured within 5 days.

### (Fixing Performance)

The liquid developer was dripped onto a polyethylene terephthalate film at room temperature (25° C.) in an environment with a 50% humidity; bar coating (the thickness of the resulting film was 13.7 μm) was performed using a wire bar (No. 6) [supplier: Matsuo Sangyo Co., Ltd.]; and a cured film was formed by exposure to an LED having an emission wavelength of 385 nm (illuminance: 1,000 mW/cm², exposure distance: 15 mm). The exposure dosage when surface tack (stickiness) was absent and curing was completed was measured and was evaluated using the following criteria.

A: at least 100 mJ/cm² and less than 500 mJ/cm²
B: at least 500 mJ/cm² and less than 1,000 mJ/cm²
C: at least 1,000 mJ/cm² and less than 2,000 mJ/cm²
D: at least 2,000 mJ/cm² or curing did not occur

The results of the evaluations in Example 1 are given in Table 4.

### Examples 2 to 12

Evaluations were carried out in Examples 2 to 12 proceeding as in Example 1, but changing the liquid developer from that in Example 1. The results of the evaluations are given in Table 4.

### Comparative Examples 1 and 2

Evaluations were carried out in Comparative Examples 1 and 2 proceeding as in Example 1, but changing the liquid developer from that in Example 1. The results of the evaluations are given in Table 4.

TABLE 1

| | | BET | alkali metal-substituted |
|---|---|---|---|
| carbon black No. | pH | (m²/g) | functional group |
| 1 | 9.0 | 65 | Na |
| 2 | 10.0 | 80 | K |
| 3 | 10.0 | 100 | none |
| 4 | 9.0 | 150 | none |
| 5 | 9.5 | 200 | none |
| 6 | 9.5 | 250 | none |
| 7 | 4.5 | 260 | none |
| 8 | 2.5 | 130 | none |

TABLE 2

| carbon black | | | presence/ |
|---|---|---|---|
| dispersing | | | absence of |
| agent No. | product name | manufacturer | amino group |
| 1 | Ajisper PB821 | Ajinomoto Fine-Techno | present |
| | | Co., Ltd. | |
| 2 | Ajisper PB881 | Ajinomoto Fine-Techno | present |
| | | Co., Ltd. | |
| 3 | Solsperse 36000 | Lubrizol Japan Limited | absent |

TABLE 3

| | materials | | | | |
|---|---|---|---|---|---|
| | | cationic | | carbon black | toner particle |
| liquid | | polymerization | | dispersing agent | diameter D50 |
| developer No. | carbon black No. | initiator | curable insulating liquid | No. | (μm) |
| 1 | 1 | A-26 | BEPDVE | 1 | 0.7 |
| 2 | 1 | A-23 | trimethylolpropane | 1 | 0.8 |
| | | | trivinyl ether | | |
| 3 | 1 | A-26 | BEPDVE | 1 | 0.7 |
| 4 | 2 | A-26 | BEPDVE | 1 | 0.7 |
| 5 | 1 | A-26 | BEPDVE | 2 | 0.7 |
| 6 | 1 | A-8 | BEPDVE | 1 | 0.7 |
| 7 | 3 | A-8 | BEPDVE | 1 | 0.9 |
| 8 | 4 | A-8 | BEPDVE | 1 | 0.9 |
| 9 | 5 | A-8 | BEPDVE | 1 | 0.5 |
| 10 | 6 | A-8 | BEPDVE | 1 | 0.7 |
| 11 | 7 | A-8 | BEPDVE | 1 | 0.7 |
| 12 | 6 | A-8 | BEPDVE | 3 | 0.7 |
| 13 | 8 | A-26 | BEPDVE | 3 | 0.7 |
| 14 | 8 | A-26 | BEPDVE | none | 0.7 |

TABLE 4

| | liquid | dark | fixing |
|---|---|---|---|
| | developer No. | polymerization | performance |
| Example No. | | | |
| 1 | 1 | AA | A |
| 2 | 2 | AA | A |
| 3 | 3 | AA | A |
| 4 | 4 | AA | A |
| 5 | 5 | AA | A |
| 6 | 6 | AA | B |
| 7 | 7 | AA | B |
| 8 | 8 | A | B |
| 9 | 9 | B | B |
| 10 | 10 | C | B |
| 11 | 11 | D | C |
| 12 | 12 | D | C |
| Comparative | | | |
| Example No. | | | |
| 1 | 13 | E | D |
| 2 | 14 | E | D |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-156444, filed Aug. 9, 2016, and Japanese Patent Application No. 2017-140110, filed Jul. 19, 2017, which are hereby incorporated by reference herein in their entirety.

What is claimed is:

1. A liquid developer comprising a curable insulating liquid, a cationic polymerization initiator, and a toner particle containing a binder resin and carbon black, wherein
the carbon black is basic.

2. The liquid developer according to claim 1, wherein the carbon black has a functional group obtained by substitution, by an alkali metal, of a hydrogen atom in an acidic group that is a surface functional group.

3. A liquid developer comprising a curable insulating liquid, a cationic polymerization initiator, and a toner particle containing a binder resin and carbon black, wherein
the toner particle contains a carbon black dispersing agent, and
the carbon black dispersing agent has a dispersing group and an adsorptive group, and the adsorptive group is an amino group.

4. The liquid developer according to claim 1, wherein the specific surface area (BET) of the carbon black is not more than 200 m²/g.

5. The liquid developer according to claim 1, wherein the cationic polymerization initiator contains a compound represented by the following formula (1); 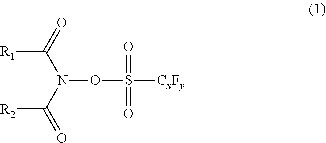
where, in formula (1), R₁ and R₂ are bonded to each other to form a cyclic structure; x represents an integer of at least 1 and not more than 8; and y represents an integer of at least 3 and not more than 17.

6. The liquid developer according to claim 3, wherein the specific surface area (BET) of the carbon black is not more than 200 m²/g.

7. The liquid developer according to claim 3, wherein the cationic polymerization initiator contains a compound represented by the following formula (1); 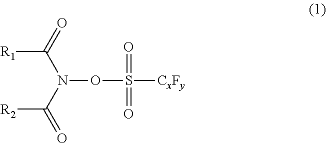
where, in formula (1), R₁ and R₂ are bonded to each other to form a cyclic structure; x represents an integer of at least 1 and not more than 8; and y represents an integer of at least 3 and not more than 17.
